(19) United States
(12) Patent Application Publication
(10) Pub. No.: US 2002/0175568 A1
(43) Pub. Date: Nov. 28, 2002

(54) Device for protecting a machine system a gainst undesired operation

(76) Inventors: Klaus Clement, Gingen (DE); Harald Forster, Sussen (DE)

Correspondence Address: HARNESS, DICKEY & PIERCE, P.L.C., P.O. BOX 828, BLOOMFIELD HILLS, MI, 48303, US

(21) Appl. No.: 10/197,157

(22) Filed: Jul. 16, 2002

Related U.S. Application Data
(63) Continuation of application No. PCT/EP01/00093, filed on Jan. 6, 2001.

(30) Foreign Application Priority Data
Jan. 17, 2000 (DE) 100 01 735.5

(51) Int. Cl. H02H 1/00

(52) U.S. Cl. 307/326

(57) ABSTRACT

The present invention describes a device for protecting a machine system against undesired operation. The protective device has at least one central power switch, which is arranged on the input side in series in a power supply path of the machine system. It also has a central control part, which has a substantially dust-tight enclosure, with a defined number of inputs for connecting decentralized operating elements. In this case, the central control part activates the at least one central power switch in accordance with the connected operating elements. The protective device also has at least one decentralized operating element, which is spatially arranged in a hazard area of the machine system and is connected via a cable connection to one of the inputs of the central control part. The decentralized operating element generates a continuing protection-request signal in accordance with a protection request and the control part opens the power switch when the continuing protection-request signal of at least one operating element is present.

### CROSS-REFERENCES TO RELATED APPLICATIONS

This application is a continuation of copending international patent application PCT/EP01/00093 filed on Jan. 6, 2001 and designating the U.S., which claims priority from German patent applications DE 100 01 735.5, filed on Jan. 17, 2000.

### BACKGROUND OF THE INVENTION

The present invention relates to a device for protecting a machine system against undesired operation. Such a protective device serves in particular for preventing uncontrolled or unintended restarting of the machine system after an operational interruption or standstill of a limited time.

It is known that machine systems, in particular those with moving axes, pose hazards to people and other machine parts. To avoid accidents, numerous safety regulations for the operation of such systems therefore exist. Nevertheless, accidents repeatedly occur, attributable in part to avoidance or neglect of safety regulations for reasons of convenience or carelessness. In addition, accidents may also be caused by a chain of unfavorable circumstances.

Especially hazardous situations, in particular in the case of complex machine systems of large volume, are constituted by setting-up, maintenance and repair work, since activities to be performed in these cases often have to be undertaken in an area of the machine system where there is a direct hazard. Therefore, it is generally necessary when carrying out these activities to switch off the machine system as a whole, or at least that part from which the direct hazard arises. In the latter case, however, a danger is not entirely excluded, since the machine system is in this case still active overall. For example, in this case, an axis which is in fact switched off can unexpectedly start again on account of a machine fault, for example a short-circuit, or on account of an operator error.

To avoid risks of this type, it is desirable to switch off the machine system as completely as possible and at the same time safely when carrying out the work mentioned above. In the case of many machine systems, this is possible by means of what is known as a main switch, which however, in the case of complex systems of large volume, is often arranged far away from the actual hazard point for design reasons. Therefore, under some circumstances long distances have to be covered to switch the machine off and on again, which can lead to the temptation not to switch off the machine system completely.

In addition, on account of the spatial separation between the main switch and the hazard area of the machine system, there is the risk that the machine system can be switched on again by one person while another person is still in the hazard area of the machine system.

Finally, in the case of a machine system, hazards also exist when all the movable axes have been reliably shut down. For example, when maintenance work is being carried out on machines which have been shut down, accidents can occur on account of still live power supply lines.

In PCT/US99/08322, which was filed with the USPTO with the present applicant as a co-applicant, a description is given of a device for protecting a machine system against undesired operation which was developed with the involvement of the applicant of the present invention in a consortium project, to avoid the hazards and problems mentioned above. The present invention is a further development of this earlier protective device which comprises a series of improvements to details within the overall concept.

### SUMMARY OF THE INVENTION

It is therefore an object of the present invention to specify an improved device for protecting a machine system against undesired operation which ensures reliable and safe protection when setting-up, maintenance or repair work is being carried out in the hazard area of the machine system.

According to one aspect of the invention, this object is achieved by a protective device of the type mentioned at the outset which has the following features:

at least one central power switch, which is arranged on the input side in series in a power supply path of the machine system,

a central control part, which has a substantially dust-tight enclosure, with a defined number of inputs for connecting decentralized operating elements, the central control part activating the at least one central power switch in accordance with the connected operating elements, and

at least one decentralized operating element, which is spatially arranged in a hazard area of the machine system and is connected via a cable connection to one of the inputs of the central control part,

the decentralized operating element generating a continuing protection-request signal in accordance with a protection request, and

the control part opening the power switch when the continuing protection-request signal of at least one operating element is present.

The combination of these features leads to a protective device which can be activated in a decentralized manner from any hazard points of the machine system, so that long distances are avoided even in the case of a complex machine system of large volume. This considerably increases the willingness to accept the protective device being put into operation when working in the hazard area of the machine system. Furthermore, the decentralized arrangement of the operating elements together with their continuing protection-request signal excludes the possibility of undesired initiation of operation from a location other than the hazard area in which work is being carried out. Accidents caused by misunderstandings between persons are therefore likewise largely ruled out. In addition, on account of the fact that the central power switch interrupts the power supply path of the machine system on the input side, the machine system as a whole is de-energized, so that, even when defective short-circuits or the like occur, hazards for operating and maintenance personnel are considerably reduced.

Furthermore, on account of the fact that the control part has a substantially dust-tight enclosure, the present protective device is very well protected against functional failures or faults. Functional failures of this type could otherwise occur, in particular on account of contamination when the machine system is in operational use or penetration of foreign bodies into the control part. This would impair both the operation and the safety of the machine system. Within the scope of the present invention, a dust-tight enclosure is understood in particular as meaning an enclosure which conforms at least to class IP 54 according to the standards IEC 529/EN 60 529.

The stated object is therefore completely achieved.

In a refinement of the invention, the power supply path supplies at least two independent loads of the machine system with power.

Independent loads in this sense are, in particular, mutually separate drives of the machine system, as are used for example in the case of machine systems capable of multi-axial movement. However, these also include all other subassemblies which are supplied by the power supply path of the machine system, for example a control unit or a current-carrying switching unit. Such subassemblies may harbor the risk of an electric shock even when the drives are at a standstill, in particular in the case of maintenance work. The measure has the advantage that a number of hazard sources, preferably even all the hazard sources, of the machine system are brought into a safe state by a central action. This has the effect on the one hand of reducing the complexity, and on the other hand of achieving an especially high level of safety with respect to operator errors.

In a further refinement of the measure stated above, one of the at least two independent loads is a control unit of the machine system.

This measure further increases safety, since in this case not only the energy supply for the movable drives of the machine system but also their activation signals are switched off. As a result, the risk of undesired restarting of a drive is further reduced.

In a further refinement of the invention, the power switch is arranged in addition to an input-side main switch in the power supply path of the machine system.

Input-side main switches are provided in many machine systems that are in use. The arrangement of the power switch in addition to these main switches makes it possible for such machines systems to be retrofitted with the protective device according to the invention easily and consequently at low cost. Furthermore, there is additional redundancy, which makes it possible for the machine system also to be centrally switched off in an already largely known and therefore customary way. Therefore, in this case even anyone who is not familiar with the new protective device can switch off the machine system in an accustomed way.

In a further refinement of the invention, the device has a monitoring unit, with which the power supply path can be reliably checked for the absence of voltage at the output of the at least one power switch.

This measure further increases safety, since the success of the switching-off operations can be reliably checked in this way. Furthermore, this allows a danger posed by electric current during maintenance or repair work to be safely excluded.

In a further refinement of the measure stated above, the at least one decentralized operating element has a control display or indicator, which can be activated in response to an acknowledgment signal of the safe monitoring unit.

The measure has the advantage that a person wishing to carry out work in the hazard area of the machine system receives clear feedback on the safe state assumed by the machine system. As a result, a reliable appraisal of the respective hazardous situation is possible, which in turn increases the safety with respect to operator errors. The control display may be realized in principle in any desired way and comprise both optical and acoustic and/or tactile signals. A clearly visible control lamp, which lights up when the machine system is in a safe state, is preferred as the control display.

In a further refinement of the invention, the central control part comprises a distributor unit, which on the input side has a multiplicity of inputs for connecting the decentralized operating elements and on the output side generates a combined protection-request signal of all the connected operating elements.

The use of a distributor unit of this type considerably increases the modularity of the protective device, which makes it possible for it to be adapted to different machine systems particularly easily and at low cost. The distributor unit is in this case preferably remote from the actual control element of the control part, which makes it possible for the protective device to be arranged very expansively. Depending on the circumstances of the machine system concerned, the control element can then even be accommodated in an enclosure that is no longer completely dust-tight, if this enclosure is far enough away from sources of contamination. However, the distributor unit, lying closer to the operating elements, then has the dust-tight enclosure mentioned at the beginning.

In a further refinement of the invention, the inputs for connecting the decentralized operating elements have multi-part cable bushings, the parts of which enclose the cable connection in a substantially dust-tight manner.

This measure has the major advantage that, on account of the multi-part and therefore separable cable bushings, the cable connection can be realized with lines which are already preassembled with suitable plugs. This makes it possible for the protective device to be installed and extended very easily and at the same time safely, which considerably increases acceptance among users. Furthermore, on account of this measure, the protective device according to the invention can be supplied very well as a modular system which can be installed by the user himself. In comparison with plugs or sockets which are accessible from the outside, cable bushings of this type are very inexpensive, while offering the same safety.

In a further refinement of the invention, the control part is arranged in its own dust-tight enclosure.

This measure has the advantage that the control part can be used very well as a modular subassembly. This allows the protective device to be retrofitted particularly easily, even in the case of relatively old existing machine systems. With the exception of the installation of the central power switch, retrofitting is then possible without interventions in and adaptations to the existing machine system.

In a further refinement of the invention, the power switch is also arranged in its own dust-tight enclosure, which has multi-part, dust-tight cable bushings for cable connections.

This measure also contributes to the easy installation of the protective device and also makes it possible for the central power switch and the central control part to be arranged spatially separate. The protective device according to the invention can therefore also be used very easily in existing, expansively distributed machine systems.

In a further refinement of the invention, which however is also in itself a preferred and advantageous further development of the protective device developed earlier, the at least one power switch has a mechanically positively driven auxiliary contact, which is incorporated in a feedback loop.

Power switches, in particular contactors, which have in addition to their make contacts mechanically positively driven auxiliary contacts, are known per se in the prior art. However, power switches of this type were not used in the case of the protective device developed earlier. Instead of this, the switching position of the make contacts of the at least one power switch was checked by complex switching measures. The stated measure has the advantage over this that, while offering the same safety, the complexity is reduced considerably. In comparison with a variant which dispenses entirely with checking the switching position of the make contacts, the measure offers a considerably increased level of safety.

In a further refinement of the invention, which likewise in itself also represents a preferred and advantageous further development, the device has an AC/AC converter, which on the input side is connected to the power supply path of the machine system and on the output side provides an operating voltage for the device.

In comparison with a simple transformer, an AC/AC converter has the advantage that it always provides a defined output voltage independently of the magnitude of its input voltage. The use of such a converter in conjunction with the present invention therefore has the advantage that the protective device can be used without adaptive measures in countries with different line voltages and in different operating environments. Fluctuations of the input-side line voltage are also equalized in this way, so that a reliable function of the protective device is also ensured in these cases. Use of the protective device according to the invention is therefore also possible safely and without any problems in countries with unstable line voltages.

In a further refinement of the invention, which likewise in itself also represents a preferred and advantageous further development, the control element has a field bus connection, via which the protection-request signals can be supplied.

A reliable field bus system, in particular what is known as the SafetyBus® of the applicant of the present invention, is preferably used as the field bus. Alternatively, however, other bus systems, for example what is known as the Interbus or what is known as the Profibus, may also be used, provided that they have corresponding safety measures. The measure has the advantage that, specifically in the case of expansive machine systems, the complexity of the cabling can be reduced considerably, whereby the overall costs for the installation of the protective device fall.

It goes without saying that the features mentioned above and those still to be explained below can be used not only in the respectively specified combination, but also in other combinations or on their own without departing from the scope of the present invention.

### BRIEF DESCRIPTION OF THE DRAWINGS

Exemplary embodiments of the invention are explained in more detail in the following description and are represented in the drawing, in which:

FIG. 1 shows a schematic representation of a first exemplary embodiment of a protective device according to the invention,

FIG. 2 shows a power unit with central power switches, which is a component part of the protective device according to the invention from FIG. 1,

FIG. 3 shows a central control element of the protective device from FIG. 1,

FIG. 4 shows a two-part cable bushing, which is used in the protective device according to FIG. 1, and

FIG. 5 shows a second exemplary embodiment of a protective device according to the invention.

### DETAILED DESCRIPTION OF PREFERRED EMBODIMENTS

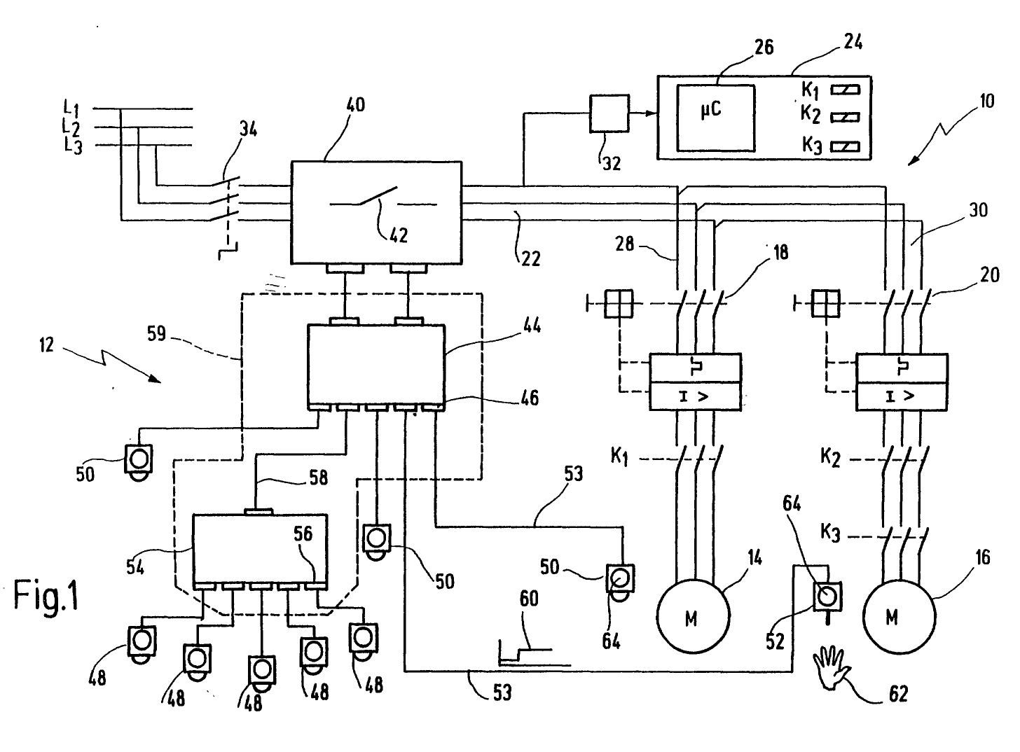

In FIG. 1, the reference numeral 10 denotes a machine system in which a protective device 12 according to the invention is used.

The machine system 10 has a multiplicity of electromotive drives, of which two drives 14, 16 are represented here by way of example. The drives 14, 16 permit mutually independent movements of the machine system 10. As an example, here this is a milling machine, in which the milling head can be moved in different axes.

Each of the two drives 14, 16 is protected in a way known per se from thermal and overcurrent loads by means of a respective motor protecting switch 18, 20. Both drives 14, 16 are connected to the same, central power supply path 22 of the machine system 10 and are supplied with energy over this path.

The reference numeral 24 denotes a control unit of the machine system 10, which in a way known per se comprises a microcomputer 26. On the output side, the control unit 24 has three turn-off contactors K₁, K₂ and K₃, the make contacts of which are arranged in series in the power supply leads 28, 30 of the drives 14, 16. The control unit 24 can individually switch off the drives 14, 16 via the contactors K₁, K₂ and K₃, which is likewise known per se. As an example of the various configurations, a single-channel disconnection is represented in the power supply lead 28 of the drive 14 and a two-channel disconnection is represented in the power supply lead 30 of the drive 16.

The control unit 24 is in the present case a safe control unit, which serves for the evaluation of emergency-off signals, protective door contacts, light barrier signals or the like. In accordance with these signals, one or more of the drives 14, 16 are individually shut down. In addition, the control unit 24 could also comprise the normal operating program of the machine system 10, in the program sequence of which the drives 14, 16 are activated. As an alternative to this, in the case of many machine systems 10, however, the drives 14, 16 are controlled in the normal operating sequence by a further control unit (not represented here), so that the control unit 24 serves alone for performing the safety functions mentioned. The different exemplary embodiments in this respect of the machine system 10 are likewise known per se and therefore need not be explained here in any more detail. The control unit 24 is represented here by way of example for all the control units present which do not belong to the protective device 12 according to the invention.

The reference numeral 32 denotes a power supply unit, which on the input side is connected to a phase of the power supply path 22 and on the output side provides an operating voltage for the control unit 24.

The reference numeral 34 denotes a main switch of the machine system 10, which is represented here as a rotary switch, as is customary in many cases.

The protective device 12 here comprises a power unit 40 with a power switch 42, explained in more detail below, a central control element 44 with a multiplicity of inputs 46 and also a total of nine decentralized operating elements 48, 50, 52, the output signals of which are fed to the central control element 44 via cable connections 53. The operating elements 48 are in this case connected to the central control element 44 via a distributor unit 54. The distributor unit 54 has on the input side a multiplicity of inputs 56, which correspond both functionally and also with regard to their mechanical construction to the inputs 46 of the central control element 44. On the output side, the distributor unit 54 generates a combined output signal, which is fed to an input 46 of the control element 44 via a cable connection 58.

Here, the control element 44 and the distributor unit 54 are arranged separately from each other. They thereby form together the region referred to in the sense of the present invention as the control part 59. In this case, the use of the distributor unit 54 is optional, however, since it serves primarily for the modular extendibility of the protective device 12. If the control element 44 itself has a sufficient number of inputs 46, it is possible to dispense with the use of the distributor unit 54. In this case, the control part of the protective device 12 then comprises only the actual control element 44.

The operating elements 48, 50, 52 are respectively arranged in a decentralized manner at those points of the machine system 10 at which an intervention into a hazard area could take place.

Each of the operating elements 48, 50, 52 generates at the request of an operator a continuing request signal 60, as is represented in the example of the operating element 52 in the region of the drive 16 by a hand 62. If the protective device 12 is operating properly, the continuing request signal 60 is present at the control element 44 until it is retracted again by the triggering operating element 52. As an example, here the operating elements 48 to 52 are represented in the form of rotary switches. As an alternative, however, any other configuration with which the change in a continuing can be signaled to the control element 44 is also conceivable. This can also take place in principle with the aid of pulse-shaped request signals 60 if the control element 44 can distinguish whether it is a switching-on or switching-off pulse.

According to a preferred exemplary embodiment of the invention, each of the operating elements 48 to 52 has a control display 64, which is realized here in the form of a visible indicator lamp. The indicator lamp 64 signals to the respective operator whether or not the machine system 10 is in a safe state.

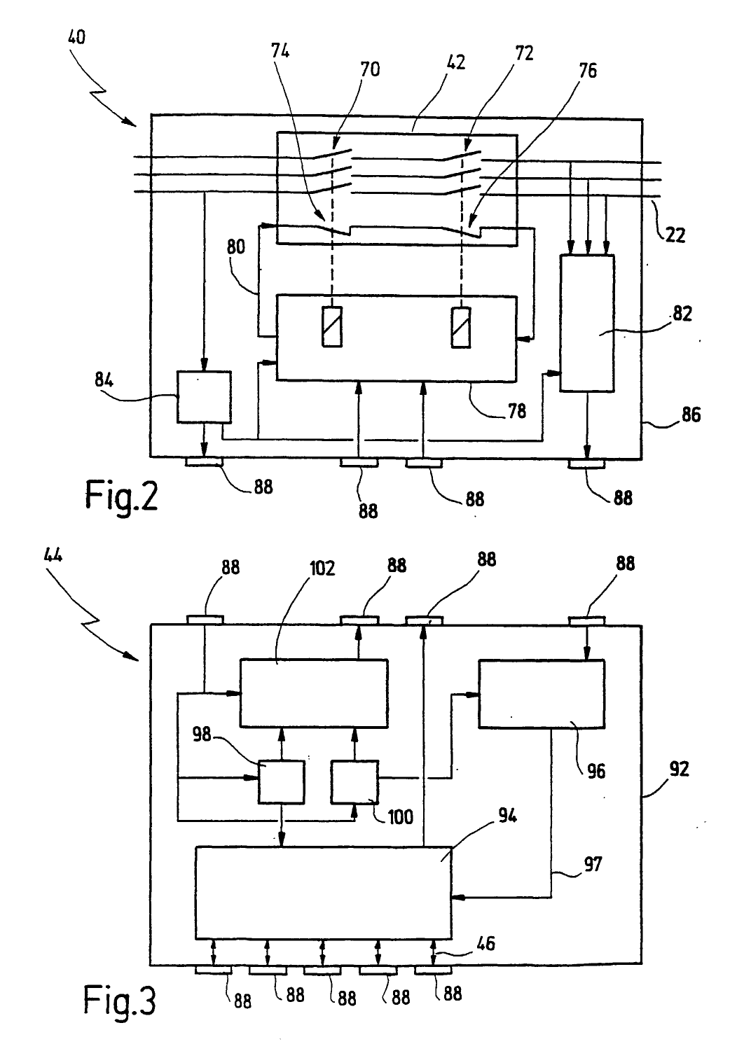

In FIG. 2, the power unit 40 is represented in more detail. As can be seen, in this exemplary embodiment, for reasons of redundancy, the power switch 42 comprises two groups of make contacts 70, 72, which are arranged in series in relation to one another and with which in each case at least one auxiliary contact 74, 76 is mechanically positively driven. In practice, the power switch 42 is realized with the aid of two contactors, arranged in series in relation to each other, with positively driven auxiliary contacts 74, 76. As can be seen from this wiring arrangement, the main power supply path 22 of the machine system 10 can be disconnected in a two-channel manner by the power switch 42.

The make contacts 70, 72 and the auxiliary contacts 74, 76 of the power switch 42 are activated via relay outputs, which are a component part of a safe circuit 78. As an alternative to this, the activation could also take place, however, via electronic outputs, for example semiconductor outputs.

The circuit 78 also has a feedback loop 80, via which the switching position of the auxiliary contacts 74, 76 can be evaluated. In this way, the make contacts 70, 72 of the power switch 42 can be reliably checked to ascertain whether they are open or closed. The feedback loop 80 in this representation is to be understood as being shown by way of example. As an alternative, the feedback loop could also be fed to another circuit of the protective device 12, for example to the central control element 44. All that is important is that the position of the make contacts 70, 72 is evaluated in a safe way on the basis of the auxiliary contacts 74, 76, to detect malfunctions of the protective device 12 at an early time and reliably.

The reference numeral 82 denotes a voltage monitoring unit, as offered for example by the applicant of the present invention under the designation PU3Z. This is a safe switching device, with which the power supply path 22 can be monitored at the output of the power switch 42 for the absence of voltage when the make contacts 70, 72 have been opened.

The reference numeral 84 denotes an AC/AC converter, which on the input side is connected to a phase of the power supply path 22 and on the output side provides a stabilized operating voltage for the circuit 78, the monitoring unit 82 and the further components of the protective device 12 described below.

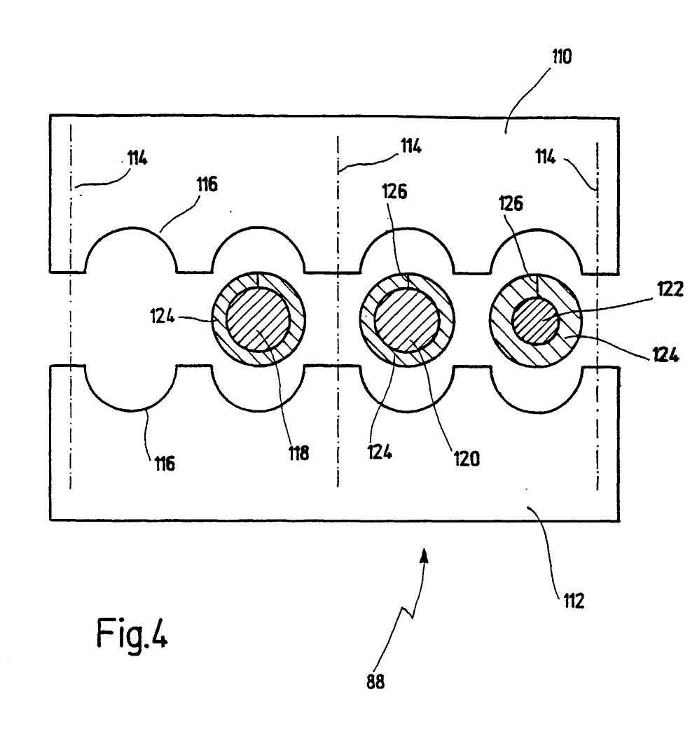

The power unit 40 is installed as a whole in its own, dust-tight enclosure 86, which has for the connection of the remaining components of the protective device 12 cable bushings 88 which can be closed in a dust-tight manner. A preferred example of a cable bushing of this type is explained in more detail below on the basis of FIG. 4.

The central control element 44 of the protective device 12 is represented in more detail in FIG. 3. For operating the protective device 12, the control element 44 of this exemplary embodiment is connected to the power unit 40 via cable connections, as is indicated in FIG. 1.

The control element 44 is also installed in its own, dust-tight enclosure 92, which has the mentioned dust-tight cable bushings 88 both at the inputs 46 and at the connections for the power unit 40.

In the interior, the central control element 44 has a safe circuit 94, which picks up the request signals 60 of the connected operating elements 48 to 52 and, in accordance with them, activates the power switch 42 via the circuit 78. The reference numeral 96 denotes a safe switching device, to which the output signal of the monitoring unit 82 is fed. In accordance with this output signal, which is able to indicate the absence of voltage at the output of the power switch 42, the switching device 96 generates an acknowledgment signal 97, which activates the control displays 64 of the operating elements 48 to 52.

The reference numerals 98 and 100 denote two DC voltage power supply units, to which the output voltage of the AC/AC converter 84 is fed. The power supply units 98, 100 generate a 24 V operating voltage for the circuit 98 and the switching device 96. Since the activation of the control display 64 of the operating elements 48 to 52 is critical to safety with regard to a malfunction, separate power supply units are preferably used here for the circuit 94 and the switching device 96. The reference numeral 102 also denotes a checking circuit, which checks the mutual isolation of the two power supply units 98, 100 with regard to the detection of ground faults and/or cross connections. The output signal of the checking circuit 102 is likewise evaluated when the power switch 42 is activated.

It goes without saying that the acknowledgement signal 97 in the circuit 94 must likewise be protected against defective short-circuits in order to rule out erroneous activation of the control displays 64. This can preferably take place by means of electrically isolated signal paths, which however is not represented in any more detail here for reasons of overall clarity.

In FIG. 4, a preferred cable bushing 88 is represented, as used in the case of the dust-tight enclosures 86, 92 of the power unit 40 and the control element 44.

The cable bushing 88 here comprises two parts 110, 112, which can be separated from each other and can be releasably connected to each other by means of screws or bolts 114. Each of the two parts 110, 112 has semicircular recesses 116, which complement one another in the fitted-together state of the two parts 110, 112 to form a full circle. The recesses 116 serve for receiving and leading through the connecting cables between the individual components of the protective device 12.

As an example, three cables 118, 120, 122 are shown in the representation in FIG. 4, the cable 122 having a smaller cross section than the cables 118, 120. To achieve a dust-tight termination in the recesses 116 in spite of the smaller cross section, plastic rings 124 of different thickness are provided, it being possible for these rings to be opened by means of a separation 126, so that they can be placed around the outer sheath of the cables 118 to 122.

The two parts 110, 112 of the cable bushing 88 can be firmly connected to a lower enclosure part (not represented here) and a corresponding enclosure cover of the enclosures 86, 92, so that the cable bushings 88 are automatically opened when the enclosures 86, 92 are opened. As an alternative to this, the cable bushings 88 may, however, also be fastened to the enclosures 86, 92 in some other way.

In further exemplary embodiments, the two parts 110, 112 of the cable bushings 88 are connected to each other by means of a tilting joint and can therefore be opened and closed in a corresponding way. In yet further exemplary embodiments, the cable bushings can be realized with the aid of flexible sponge-rubber elements lying opposite one another, between which the cable connections are received. What is important with regard to the present invention is that the cable bushings 88 are designed in such a way that the cables 118 to 122 can be led into the enclosures 86, 92 in an easy way even if they are already preassembled with plugs of an outside diameter that is larger than the outside diameter of the cables 118 to 122 themselves.

Consequently, the protective device according to the invention works as follows:

During normal operation of the machine system 10, the power switch 42 with its make contacts 70, 72 is closed, so that the control unit 24 and the drives 14, 16 are supplied with power. If an operator of the machine system 10 then has to intervene in one of the hazard areas of the machine system 10 for setting-up, maintenance or repair work, he will put the machine system 10 into a state of rest to comply with the safety regulations. This can take place for example by means of an input at the control unit 24 or a further control unit of the machine system 10 not represented here.

To ensure that the machine system 10 does not unexpectedly start again or is put into operation during the work to be carried out in the hazard area, the operator also actuates the operating element nearest him, as is represented in FIG. 1 by way of example for the operating element 52. The operating element 52 responds by generating the continuing request signal 60, as a consequence of which the control element 44 opens the make contacts 70, 72 of the power switch 42. With the aid of the monitoring unit 82, the absence of voltage at the output of the power switch 42 is then checked. As soon as the absence of voltage is established, the monitoring unit 82 in conjunction with the switching device 96 generates the acknowledgement signal 97, which is fed to the operating elements 64 for the activation of the control displays 64. The operator then knows that the machine system 10 is in a safe state, posing no hazard.

For the deliberate restarting of the machine system 10, after carrying out his intended work, the operator deactivates the request signal 60 with the aid of the same operating element 52 that he previously actuated. If no further request signal 60 of a further operating element 48, 50 is present, the machine system 10 can subsequently be put into operation by input of a start command, preferably at the control unit intended for this purpose.

It is evident from the description that the operating elements 48 to 52 are present in addition to all the switching-off possibilities already provided earlier. The operating elements do not serve for influencing the machine system itself during the normal operating sequence. They are also not intended here for an emergency-off function. As a consequence of this, the operating elements 48 to 52 differ from known emergency-off buttons, to be precise in particular by the fact that they have two continuing switching positions, with which two different states of the request signal 60 can be manually produced. On account of the serial arrangement of the power switch 42, the protective device 12 can, however, nevertheless also be used in an individual case for an emergency-off function.

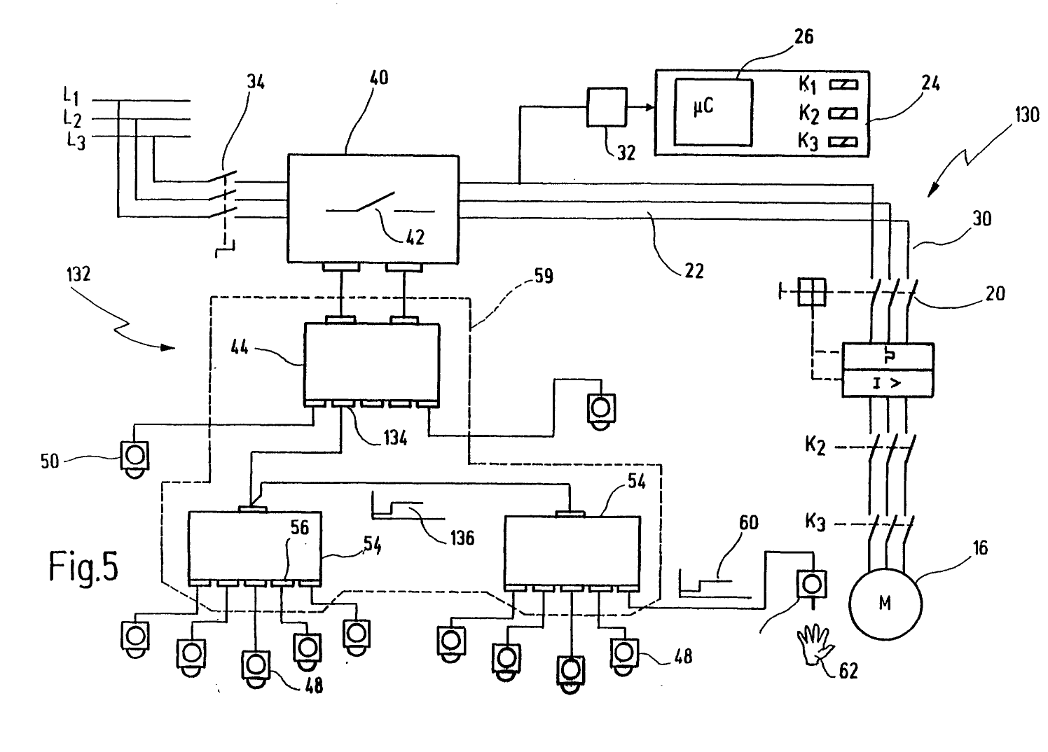

In FIG. 5, a further exemplary embodiment of the invention is represented on the basis of a machine system 130. The protective device according to the invention is in this case denoted overall by the reference numeral 132. Otherwise, the same reference numerals denote the same elements as in the previous Figures.

For the sake of overall clarity, the machine system 130 is represented in FIG. 5 with only one drive 16. It goes without saying, however, that, in the case of this exemplary embodiment too, the machine system 130 may comprise any desired number of drives 16.

The protective device 132 differs from the protective device 12 in particular in that the control element 44 has a field bus connection 134, via which a number of distributor units 54 can be jointly connected to the control element 44. In this case, the combined request signals 136 of all the connected distributor units 54 are fed to the control element 44 via the field bus connection 134.

The field bus is preferably what is known as a Safetybus, which has been developed by the applicant of the present invention on the basis of in what is known as the CAN bus. In principle, however, any other safe bus system is also suitable for the use concerned here.

Otherwise, the protective device 132 works in a way corresponding to the protective device 12.

In a further exemplary embodiment of the invention, not represented here, individual operating elements 48 to 52 can also be connected to the central control element 44 via a common field bus. As a result, the complexity of the cabling during the installation of the protective device 132 is again reduced, although in this case there have to be corresponding bus controllers in the individual operating elements 48 to 52.

What is claimed is:

1. In a machine system comprising an input side and a power supply path, a device for protecting said machine system against undesired operation, said device comprising:
at least one central power switch arranged on said input side of said machine in series with said power supply path,
at least one decentralized operating element spatially arranged in a hazard area of said machine system, and
a central control part being sealed in a substantially dust-tight enclosure, said central control part having a defined number of inputs for connecting said at least one decentralized operating element via at least one cable connection,
wherein said central control part controls said at least one central power switch in response to said at least one decentralized operating element,
wherein said at least one decentralized operating element generates a continuing protection-request signal in response to a protection request from an operator, and
wherein said control part opens said power switch when said continuing protection-request signal from said at least one operating element is present.

2. The device of claim 1, wherein said machine system comprises at least two independent loads, and said power supply path supplies said at least two independent loads with power.

3. The device of claim 2, wherein one of the at least two independent loads is a control unit of said machine system.

4. The device of claim 1, wherein said machine system further comprises an input-side main switch arranged in said power supply path, and said power switch is arranged in addition to said input-side main switch in said power supply path.

5. The device of claim 1, wherein said power switch comprises a power switch output side, and said device further comprising a fail-safe monitoring unit connected to said power supply path at said power switch output side for reliably checking for an absence of voltage at said power switch output side.

6. The device of claim 5, wherein said fail-safe monitoring unit generates an acknowledgment signal when absence of power is detected on said power supply path, and wherein said at least one decentralized operating element comprises an indicator activated in response to said acknowledgment signal.

7. The device of claim 1, wherein said central control part comprises a distributor unit with a distributor input side and a distributor output side, wherein a plurality of inputs for connecting decentralized operating elements is provided on said distributor input side, and wherein said distributor unit generates a combined protection-request signal of all the connected operating elements on said distributor output side.

8. The device of claim 1, wherein said inputs for connecting said decentralized operating elements comprise multi-part cable bushings, the parts of which enclose said cable connection in a substantially dust-tight manner.

9. The device of claim 1, wherein said control part is sealed in said dust-tight enclosure on its own.

10. The device of claim 1, wherein a second dust-tight enclosure is provided having multi-part, dust-tight cable bushings for guiding cable connections, said second dust-tight enclosure sealing said power switch.

11. The device of claim 1, wherein said at least one power switch comprises at least one mechanically positively driven auxiliary contact for incorporating in a monitoring feedback loop.

12. The device of claim 1, further comprising an AC/AC converter having a converter input side and a converter output side, wherein said converter input side is connected to said power supply path of said machine system and wherein said converter output side provides an operating voltage for said device.

14. The device of claim 1, wherein said at least one cable connection is a field bus for connecting a plurality of said decentralized operating elements to said control part, and said control part comprises a field bus connection terminal for receiving said protection-request signals from said decentralized operating elements via said field bus.

15. In a machine system comprising an input side, a power supply path, and a main switch arranged in said power supply path at said input side, a device for protecting said machine system against undesired operation, said device comprising:
at least one central power switch arranged in addition to said main switch on said input side of said machine in series with said power supply path,
a plurality of decentralized operating elements, each of said decentralized operating elements generating a continuing protection-request signal in response to a protection request from an operator,
a field bus, and
a central control part for controlling said at least one central power switch, said central control part having a field bus connection terminal connected to said field bus for receiving said protection-request signals from said decentralized operating elements,
wherein each of said plurality of operating elements is spatially arranged in a hazard area of said machine system, and
wherein said control part opens said power switch when said continuing protection-request signal of at least one operating element is present.

16. In a machine system comprising an input side, a power supply path, and a main switch arranged in said power supply path at said input side, a device for protecting said machine system against undesired operation, said device comprising:
at least one central power switch arranged on said input side of said machine in series with said power supply path,
a plurality of decentralized operating elements each being spatially arranged in a hazard area of said machine system,
a central control part having a defined number of inputs for connecting said decentralized operating elements, said central control part controlling said at least one central power switch in response to said operating elements connected, and
an AC/AC converter having a converter input side and a converter output side, wherein said converter input side is connected to said power supply path of said machine system and wherein said converter output side provides an operating voltage for said device,
wherein each of said decentralized operating elements generates a continuing protection-request signal in response to a protection request from an operator, and
wherein said control part opens said power switch when said continuing protection-request signal from at least one operating element is present.
